(19) United States
(12) Patent Application Publication
(10) Pub. No.: US 2008/0254744 A1
(43) Pub. Date: Oct. 16, 2008

(54) DATA DISTRIBUTION SYSTEMS

(76) Inventor: Graham Tricker, Norfolk (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/747,319

(22) Filed: May 11, 2007

(30) Foreign Application Priority Data
Apr. 13, 2007 (GB) GB0707138.4

(51) Int. Cl. H04B 7/00

(52) U.S. Cl. 455/41.2

(57) ABSTRACT

A communication system of the type in which a base station, which can take the form of an electronic tag, is used to send data to users of wireless mobile units. The tags are used in environments such as on poster panels and in football grounds to deliver information relevant to that environment, e.g. information concerning the product advertised on the poster. A problem is that people who do not want the information offered by the base station will receive an invitation that they regard as a nuisance leading to negative association towards the brand. The invention seeks to overcome this problem by transmitting an enquiry signal at a relatively low power so that only mobile units in relatively close proximity to the base station will receive an invitation but uses a relatively high power when transmitting information to mobile units that have accepted the invitation.

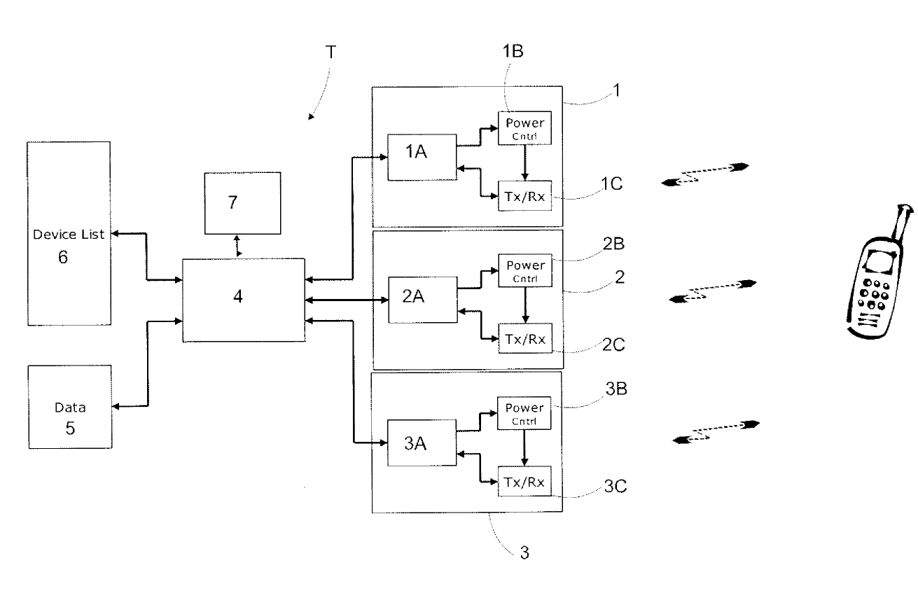

### BACKGROUND OF THE INVENTION

1. Field of the Invention

This invention relates to a communication system of the type in which a base station, which can take the form of an electronic tag is used to send data to users of wireless mobile units. These tags are used in environments such as on poster panels, festival sites, trade shows, train stations, football grounds to deliver information relevant to that environment. For example a tag on a poster panel might deliver more detailed information concerning a product advertised on the poster. The wireless mobile unit can be a mobile phone, personal digital assistant or other mobile electronic unit.

2. Prior Art

Such systems normally use a short range wireless Communication protocol such as Bluetooth which has a common operating range of about 10 metres (though can be 100 m+ depending on Bluetooth radio). With such a system a mobile user entering the 10 m range will, receive an invitation for the relevant data on his/her mobile.

A problem is that people who do not want the information offered by the base station will receive an invitation that they regard as a nuisance. This can produce a negative brand image where the information is in the form of advertising.

### SUMMARY OF THE INVENTION

According to the invention there is provided a radio communication system comprising:
(a) a base station;
(b) a store of data to be transmitted to mobile units from the base station;
(c) means for transmitting from the base station at a relatively low power a signal enquiring what mobile units are within range at that low power;
(d) means for receiving at the base station responses to the enquiry signal from mobiles within that short range;
(e) means for storing the identities of the mobiles that have responded; and
(f) means for transmitting the data from the base station at a relatively high power to mobiles whose identities are held in the store.

By employing the invention it becomes possible for mobile units only in close proximity of the base station to be sent invitation to receive information, this closeness being selected so that the users of such mobiles can be reasonably be assumed to have a real interest in the data.

In a preferred embodiment of the system the base station comprises the store of data to be transmitted to mobile units and means for storing the identities of the mobiles that have responded. The system favourably comprises a number of transceiver modules, means for causing each module to transmit the data to a mobile identified in the store; and means for causing the module to switch to an enquiry state in which it enquires what mobiles are within range, dependant on it having finished a data transmission, there being no entries in the store and there being no other modules doing an enquiry. In this way it is possible to deliver information to the maximum possible number of mobile users without risk of offering the information in circumstances where the system does not have the capacity to deliver it promptly. This capacity can, however, be increased simply by increasing the number of modules in the base station.

Each module is preferably of the type that establishes a control loop between the module and a mobile whereby transmission power can be dynamically controlled depending on the strength of a received signal. Modules of this type have a built-in facility for controlling transmission power and that facility can be used to limit the transmission power when the enquiry signal is being transmitted.

It is further preferable that the system includes means for adjusting the level of the low power signal.

It is favourable in some embodiments to include authentication means for identifying a master mobile and for using data from that master to adjust the transmission power level for the enquiry signals to update the data and to update the firmware.

In accordance with another aspect of the invention there is provided a radio communication system comprising a base station comprising:
a store of data to be transmitted to mobile units;
means for transmitting at a relatively low power a signal enquiring what mobile units are within range at that low power;
means for receiving responses to the enquiry signal from mobiles within that short range;
means for storing the identities of the mobiles that have responded; and
means for transmitting the data at a relatively high power to mobiles whose identities are held in the store.

### BRIEF DESCRIPTION OF THE DRAWING

The invention will now be described by way of example with reference to the accompanying drawing which shows a block diagram of a radio communication data distribution system constructed in accordance with the invention.

### DETAILED DESCRIPTION OF THE PREFERRED EMBODIMENT

Referring to the drawing there is shown a radio communication data distribution system for incorporation within an electronic tag device T at a location accessible to the public. In this example the tag T is associated with a marketing poster panel at a bus stop. The tag has three transceiver modules 1, 2, 3 in the form of short range wireless Bluetooth® chips. As is conventional in such modules, each has a chip controller 1A, 2A, 3A, transmission power controller 1B, 2B, 3B and a transceiver unit 1C, 2C, 3C.

The chip controllers 1A, 2A & 3A control the hop sequence of its corresponding transceiver 1C, 2C, & 3C so as to switch, according to a pseudorandom sequence, between different permitted frequencies within a specified frequency range. Each controller also controls the power controller 1B, 2B, 2B to dynamically adjust the transmission power of the transceiver either for enquiry, or during connection with a mobile unit. In a standard Bluetooth connection, the transmit powers of the connected devices are dynamic and will fluctuate depending upon the strength of the signal received by the other device. The power level is set by a chip controller 1A which instructs the power controller 1B. Standard Bluetooth chips are ‘factory’ set such that the controller can adjust the transmit power to have a range anywhere from between a few centimeters to 10 meters and beyond. The chip controllers are conventionally pre-programmed to set the power transmission to a maximum during enquiry broadcasts to increase the probability of finding available devices.

There is a facility in Bluetooth® system to limit the power of transmission within a specific range of powers which may utilised by putting a ‘bar’ on the maximum power which the transceiver can transmit. This can be done by setting the maximum transmit power threshold using the Bluetooth specification host controller interface.

The Bluetooth specification specifies an HCI (host controller interface). In order to manipulate the power level on the Bluetooth® module, an HCI specification which outlines each of the HCI commands and how to implement them can be found at www.bluetooth.org.

All three modules 1, 2, 3 are connected to the master controller 4 which:
a) instructs each of the transceiver modules as to whether to transmit in a enquiry mode or to establish a connection with a found mobile device (connection mode),
b) instructs the data to be downloaded, and
c) specifies a range of powers levels within which the power control may operate.

Also forming part of the system is a data store 5 holding information which is to be transmitted to mobile devices, and volatile memory storage 6 which holds the addresses of the mobile devices found during the enquiry. Both the data store 5 and device list 6 are linked to the system via the master controller 4.

In this embodiment information stored on the data storage 5 is likely to relate to the poster to which the tag is associated and may include text, pictures, video or audio material. The data storage may hold various different versions of the information which can be selected depending upon the technical specification of the mobile device being serviced.

In operation the master controller 4 continuously scans the modules 1, 2, 3 until it finds one that is not in use. If there are no entries in the register 6 (to be described later) the master controller then sends a command to module 1, 2 or 3 to make a ten second enquiry broadcast. Included in this command is the maximum transmission power which can be used for the enquiry, this being pre-programmed in the master controller. The controller, e.g. 1A, of the selected module causes its transceiver Tx/Rx to start an enquiry broadcast across a particular frequency hopping sequence. It also instructs the power control 1B to set the transmit power to its highest within the range specified by the master 4, although the range of the broadcast signal will depend upon a variety of factors such as the receiver in the mobile unit, it is thought that an acceptable maximum range for a typical poster location would be <1 m to 3 meters. As a consequence only persons who are in very close proximity to the poster, who are the people most likely to be looking at the poster, will receive an invitation to accept content from the data store 5. People who happen to be passing through the general area of the poster e.g. between 1-10 meters away who may not have even seen it, will be excluded from the invitation.

Mobile devices which are found within range of this low power enquiry interpret it as an invitation to receive content from the data store 5. If they accept this invitation, a message is transmitted back to the module 1 containing a unique identity code for the mobile together with other information such as the mobile's media display capabilities. The controller 4 stores this information as one item in a list held in a register 6. The devices are stored in the order in which they are found.

The master controller 4 contains data concerning different types of mobile device. If, during its scan of modules 1, 2, 3, it identifies a module not in use when there is at least one entry in the register 6, it selects, from store 6, data suitable for transmission to the mobile specified in that oldest entry. It then deletes the entry and sends the selected data to the identified module with an instruction to transmit it to the specified mobile. With this instruction is also a specified power range. This power range is wider and has a much higher top limit (compared with the range given when instructing an inquiry broadcast) so as to allow transmissions up to the standard maximum power setting of Bluetooth chips (˜10 meters).

The chip controller (eg. 2A) of the module instructed to transmit the data arranges a hopping sequence (piconet) for each data-sending operation and controls the power control 2B during transmission of the data within the specified power range. Because of the greater power range, as compared with that used during the enquiry broadcast, the mobile device is still able maintain a connection with the system should the device move from its position when detected during the enquiry broadcast within a ˜10 metre radius. This is of particular importance because downloads may take as long as 30-60 seconds to complete in which time the user of the mobile device is likely to move away from poster.

It is likely that at some point during the operation of the tag it will be required to update the information stored within the data store 5 or the firmware of the system. This is particularly necessary when the poster is changed. It may also be wished to adjust the ranges of the power controls of the enquiry broadcast depending on the environmental factors of the location of the tag, e.g. its proximity to a pavement, its accessibility to the public etc.

For this purpose, an authentication store 7 is included. This holds the unique identity or identities of one or more master mobile device(s). When any mobile device is discovered during enquiry, the controller 4 checks its identity for a match with the known identities of mobile devices authorised to act as “master” devices. If such a match is detected the system is enabled to download information from the master mobile device, relating to firmware and data for the store 5.

An example of suitable hardware to be incorporated for use for the master controller 4 is an Atmel AT91RM3400 processor. The data store 5 and authentication store 7 could use Atmel AT45DB321C dataflashs.

In an alternative embodiment the master controller 4, data store 5, and device list 6 are located remotely from the Bluetooth modules 1, 2, 3. The tag T housing the modules 1, 2, 3 and a transceiver, communicate with a remote station via a telecommunications link which could be wired or wireless. A second transceiver, the master controller 4, data store 5 and device list 6. Operation would occur substantially in the same way except that communications between the modules 1, 2, 3 and the master 4 would pass through the two transceivers.

1. A radio communication system comprising:
(a) a base station;
(b) a store of data to be transmitted to mobile units from the base station;
(c) means for transmitting from the base station at a relatively low power a signal enquiring what mobile units are within range at that low power;
(d) means for receiving at the base station responses to the enquiry signal from mobiles within that short range;
(e) means for storing the identities of the mobiles that have responded; and
(f) means for transmitting the data from the base station at a relatively high power to mobiles whose identities are held in the store.

2. A system according to claim 1 comprising a number of transceiver modules means for causing each module to transmit the data to a mobile identified in the store; and means for causing the module to switch to an enquiry state in which it enquires what mobiles are within range, dependant on it having finished a data transmission, there being no entries in the store and there being no other modules doing an enquiry.

3. A system according to claim 1 characterised in that each module comprises means for establishing a control loop between the module and a mobile whereby transmission power can be dynamically controlled depending on the strength of a received signal; and means for limiting the transmission power.

4. A system according to claim 1 including means for adjusting the level of the low power signal.

5. A system, according to claim 1 including authentication means for identifying a master mobile and for using data from that master to adjust the level, and/or to update the store of data and/or to update firmware.

6. A system according to claim 1 in which the system uses a short range frequency hopping protocol.

7. A system according to claim 1 in which the base station comprises the store of data to be transmitted to mobile units and means for storing the identities of the mobiles that have responded.

8. A radio communication system comprising a base station comprising:
a store of data to be transmitted to mobile units;
means for transmitting at a relatively low power a signal enquiring what mobile units are within range at that low power;
means for receiving responses to the enquiry signal from mobiles within that short range;
means for storing the identities of the mobiles that have responded; and
means for transmitting the data at a relatively high power to mobiles whose identities are held in the store.
